(19) United States
(12) Patent Application Publication
(10) Pub. No.: US 2010/0188973 A1
(43) Pub. Date: Jul. 29, 2010

(54) QUALITY OF SERVICE (QOS) CONTROL FOR TRANSPORT INDEPENDENT ARCHITECTURES

(75) Inventors: Arto Tapio PALIN, Viiala (FI); Juha-Matti Mikael TUUPOLA, Tampere (FI)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/362,037

(22) Filed: Jan. 29, 2009

(51) Int. Cl. H04L 12/26

(52) U.S. Cl. 370/230

(57) ABSTRACT

A system for facilitating access to resources residing within an operating environment comprising multiple apparatuses. After identifying a requirement for accessing a resource, a determination may be made as to whether the resource resides in the operating environment. If the resource resides on apparatuses (e.g., providers) in the operating environment, a determination of communication transports that are usable for accessing each provider may be made. When multiple transports are determined to be usable, at least one transport may be selected based on a required Quality of Service (QoS).

### BACKGROUND

1. Field of Invention

The present invention relates to resource access in multi-device architectures, and more specifically, to facilitating access to resources that may be situated on other apparatuses using one or more transports that may be selected based on a required Quality of Service (QoS).

2. Background

In general, software programs may include executable instruction sets that are organized in a manner to cause a processing device to receive input (e.g., data) for a calculation or determination that may then result in an output. Over the years, software technology has evolved to transform these individual instruction sets into modules that may in turn be integrated together to form the more complex programs we know today. Today's more-sophisticated software programs may receive various forms of input such as raw data, for example as stored in magnetic or optical storage, user input through various known types of user interfaces, measured or monitored information converted to electronic information from electronic and/or electromechanical sensors, etc.

In some instances, programs may be configured to produce data usable by other software applications. However, problems may arise when conveying information between these programs. If an information exchange scenario is known before the interacting programs are created, then a specific strategy may be devised to convert one program's output into another program's input. Traditionally this strategy has led to functional but extremely rigid software application configurations, requiring frequent and possibly substantial revisions due to changes in functionality, platform, architecture, etc.

The inflexibility described above may further contribute to confusion and frustration caused by the complication involved in configuring software and/or apparatus interaction. For example, when exchanging information between applications residing on separate apparatuses, users must not only comprehend how to configure the applications so that they can interact, but also the underlying communications needed to link the apparatuses. Existing architectures require users to have independent knowledge of the resources on each apparatus, the communication abilities of each apparatus and how the application/apparatus should be configured in order to perform the desired transaction. Some or all of this knowledge is often outside of the skill level of an average user.

### SUMMARY

Various example embodiments of the present invention may be directed to a method, apparatus, computer program product and system configured for facilitating access to resources residing within an operating environment comprising multiple apparatuses. After identifying a requirement for accessing a resource, a determination may be made as to whether the resource resides in the operating environment. If the resource resides on apparatuses (e.g., providers) in the operating environment, a determination of communication transports that are usable for accessing each provider may be made. When multiple transports are determined to be usable, at least one transport may be selected based on a required Quality of Service (QoS).

The at least one transport for accessing the resource situated on another apparatus may be selected based on QoS criteria. In accordance with at least one example embodiment of the present invention, the QoS criteria may be provided by a resource consumer (e.g., programs that spawned the resource access requirement) in view of operational needs. Examples of QoS criteria may include, but are not limited to, required communication speed, required data capacity, required error level threshold, etc. The abilities of the communication transports may then be evaluated against the QoS criteria for selecting at least one usable transport. Where more than one usable transport exists, the usable transports may be placed in a preferred order of use.

In situations where selected providers and/or transports are not successful in providing access to the resource, or are not able to provide the requested QoS, various example implementations of the present invention may alter the current resource access configuration. For example, an alternative transport and/or provider may be selected. Reconfiguration of the transports/providers may continue until the access requirement is satisfied. The selection of these transports/providers may be done in order, for example, based on preferred order of use.

The foregoing summary includes example embodiments of the present invention that are not intended to be limiting. The above embodiments are used merely to explain selected aspects or steps that may be utilized in implementations of the present invention. However, it is readily apparent that one or more aspects, or steps, pertaining to an example embodiment can be combined with one or more aspects, or steps, of other embodiments to create new embodiments still within the scope of the present invention. Therefore, persons of ordinary skill in the art would appreciate that various embodiments of the present invention may incorporate aspects from other embodiments, or may be implemented in combination with other embodiments.

### DESCRIPTION OF DRAWINGS

The invention will be further understood from the following description of various example embodiments, taken in conjunction with appended drawings, in which:

FIG. 1 discloses the example levels of a wireless communication architecture in accordance with at least one embodiment of the present invention.

FIG. 2 discloses an example link between two wireless communication devices in accordance with at least one embodiment of the present invention.

FIG. 3 discloses an example of services being utilized to create service nodes on a billboard in accordance with at least one embodiment of the present invention.

FIG. 4A discloses an example Network on Terminal Architecture in accordance with at least one embodiment of the present invention.

FIG. 4B discloses an example transport table in accordance with at least one embodiment of the present invention.

FIG. 5 discloses an example of communication to a billboard utilizing a connection map in accordance with at least one embodiment of the present invention.

FIG. 6A-6E discloses an example of an application querying and selecting a service in accordance with at least one embodiment of the present invention.

FIG. 6F discloses an example of the provision of services between devices using a billboard in accordance with at least one embodiment of the present invention.

FIG. 7 discloses an example scenario wherein apparatuses are interacting in accordance with at least one embodiment of the present invention.

FIG. 8A discloses an example implementation of the present invention, in accordance with at least one embodiment.

FIG. 8B discloses an alternative example implementation of the present invention, in accordance with at least one embodiment.

FIG. 9 discloses an example application of the various example embodiments of the present invention, in accordance with at least one embodiment.

FIG. 10A discloses a flowchart for an example resource access process in accordance with at least one embodiment of the present invention.

FIG. 10B discloses a flowchart for an example on-the-fly resource access management process in accordance with at least one embodiment of the present invention.

### DESCRIPTION OF EXAMPLE EMBODIMENTS

While the invention has been described below in terms of a multitude of example embodiments, various changes can be made therein without departing from the spirit and scope of the invention, as described in the appended claims.

### I. System Architecture

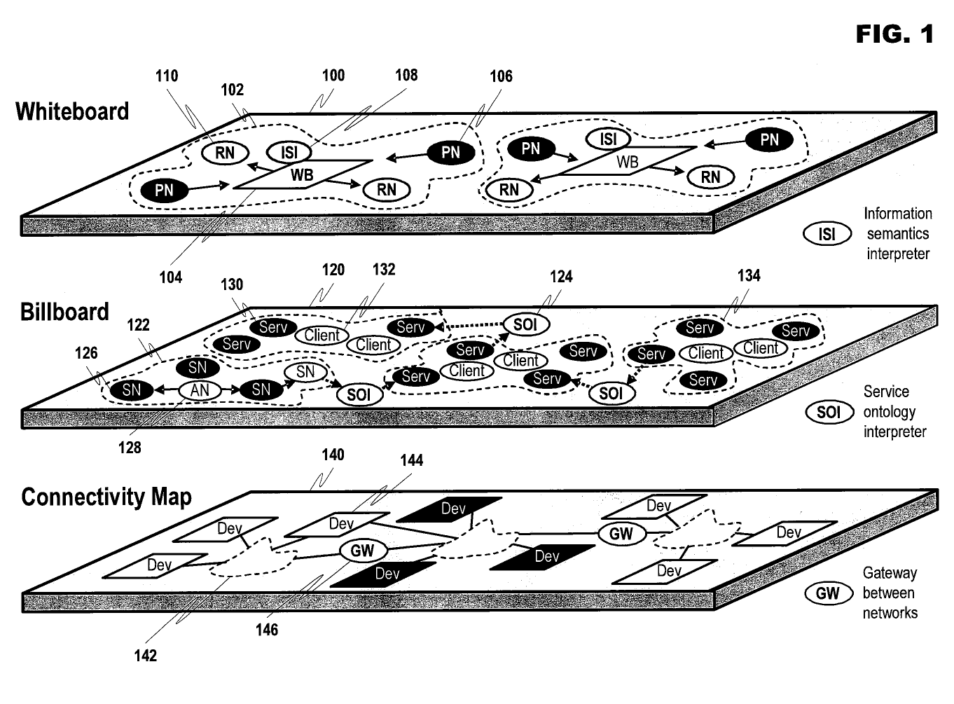

An example wireless communication architecture in accordance with at least one embodiment of the present invention is disclosed in FIG. 1. While the present invention focuses mainly on Billboard 120 and Connectivity Map 140, Whiteboard 100 is also disclosed for contextual purposes. Whiteboard 100 may comprise the highest level of operation in this architecture. At this level, operational groups 102 may be formed including whiteboards 104 and various application nodes. Application nodes may correspond to application existing on a plurality of wireless communication devices, and may be utilized to exchange information between these applications, for example, by placing data into, and removing data from, whiteboard 104. For example, the various nodes may consist of proactive nodes (PN) 106 that may be utilized to place information into whiteboard 104, reactive nodes (RN) 110 may be utilized to take information from whiteboard 104. Information semantics interpreter (ISI) 108 may be utilized to link different whiteboards together. Utilizing these constructs, Whiteboard 104 may provide a standardized means for application interaction that overcomes many incompatibilities.

Billboard level 120 may facilitate interaction between services available on the one or more devices. For instance, Billboard level 120 may enable the sharing of service-related information (e.g., service identification information, functionality, etc.), as well as any information that may be necessary in order to access and/or utilize each service. Services 130 and clients 120 that may utilize these services may be organized in service domains 122. In at least one scenario, service domains 122 may correspond to a particular protocol, such as Universal Plug and Play (UPnP), Bluetooth™ Service Discovery Protocol (BT SDP), Bonjour, etc. In each service domain 122, services 130 may be represented by service nodes (SN) 126, and likewise, application nodes (AN) 128 may be established to correspond to applications. Further, service domains 122 may interact utilizing service ontology interpreters (SOI) 124. SOI 124 may allow service domains 122 to interact with other service domains 122 in the service level, even if the service domains 122 reside on different wirelessly-linked devices (e.g., to provide access information to other service domains 122).

Connectivity map 140 may define available connectivity methods/possibilities and topology for different devices participating in sharing resources in order to support whiteboard 100 and billboard 120. In at least one embodiment of the present invention, devices 144 may be linked in directly connected groups 142. Examples of directly connected groups of devices (Dev) 142 may include devices connected via Bluetooth™ piconet, a WLAN network, a wUSB link, etc. Each directly connected group of devices 142 may further be linked by gateways (GW).

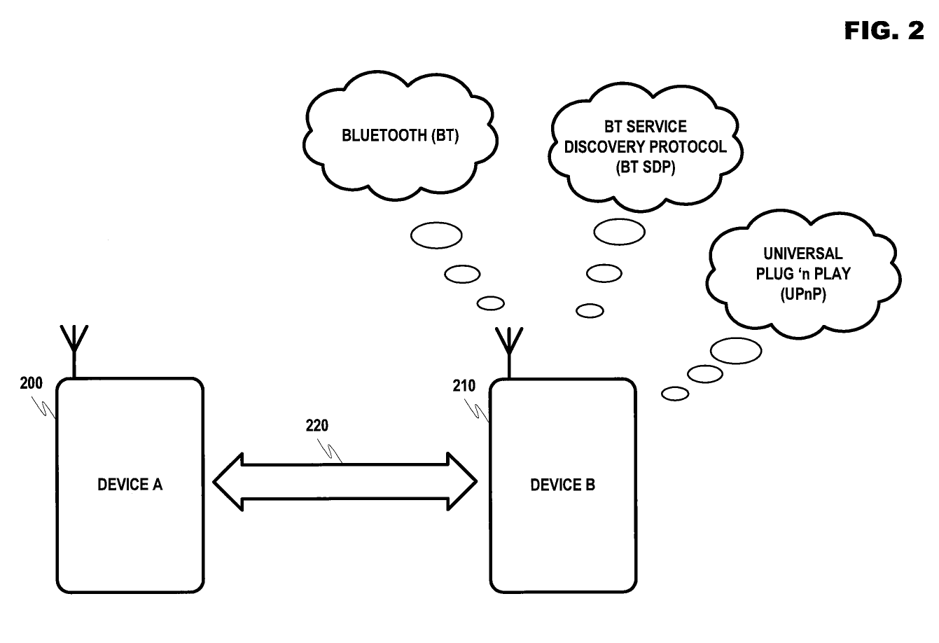

While FIG. 1 discloses an overall communication architecture usable with various example embodiments of the present invention, for the sake of explanation in the present disclosure, a much more rudimentary scenario will be utilized to illustrate service node related functionality. FIG. 2 discloses device A 200 and device B 210. Examples of devices usable in instance may include various wireless communication devices ranging from very basic wireless devices like wirelessly-enabled sensors or cellular handsets to more complex wirelessly-enabled computing devices like laptop or palmtop computers, wireless communicators, personal digital assistants, or any similar devices with wired connectivity interfaces. The devices disclosed in FIG. 2 may be linked via wireless communication 220 (e.g., WLAN), for example, in order to form an ad-hoc network between the devices. Device B 210 may further include a variety of services and service search mechanism such as Bluetooth™-related BT SDP and UPnP. Under existing architecture schemes, device A 200 would not be aware of these services over wireless link 220, and further, even if device A 200 was aware, most or all of these services would probably be inaccessible due to various incompatibility issues existing between services. As a result, wireless coupling 220 between Device A 200 and Device B 210 may only be beneficial for conveying information, since no access to remote services is available.

### II. Service Node Implementation

A service may be defined as the functionality offered or derived from a particular software program. Services may pertain to all aspects of device functionality. Services may be provided, for example, by an operating system loaded on a wireless communication device, or may be added to the device by accessory applications related to communication, security, productivity, device resource management, entertainment, etc. In accordance with at least one embodiment of the present invention, one or more service nodes may be established to correspond to services available on the one or more devices.

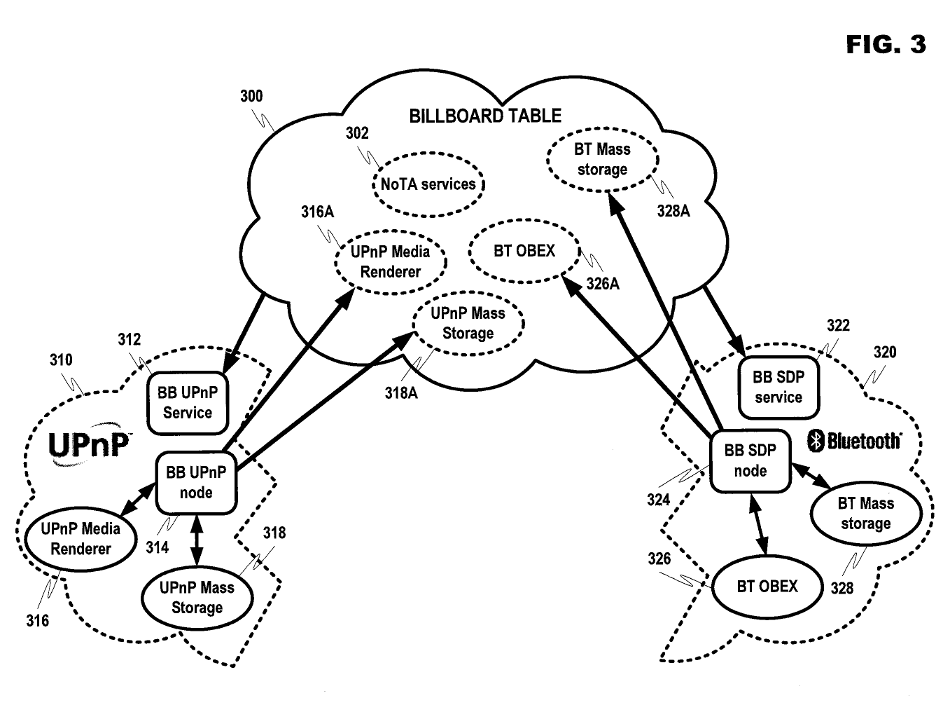

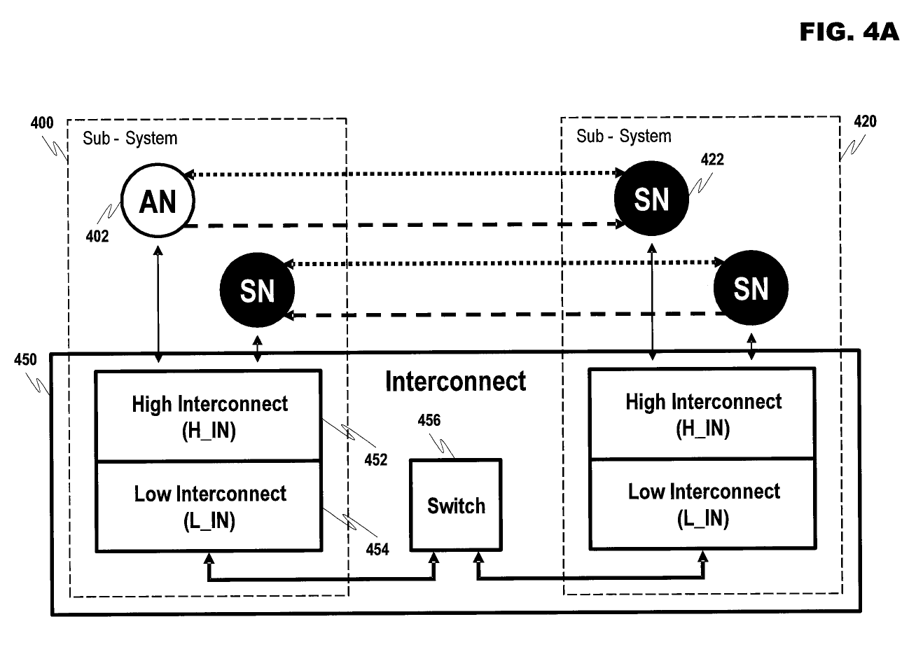

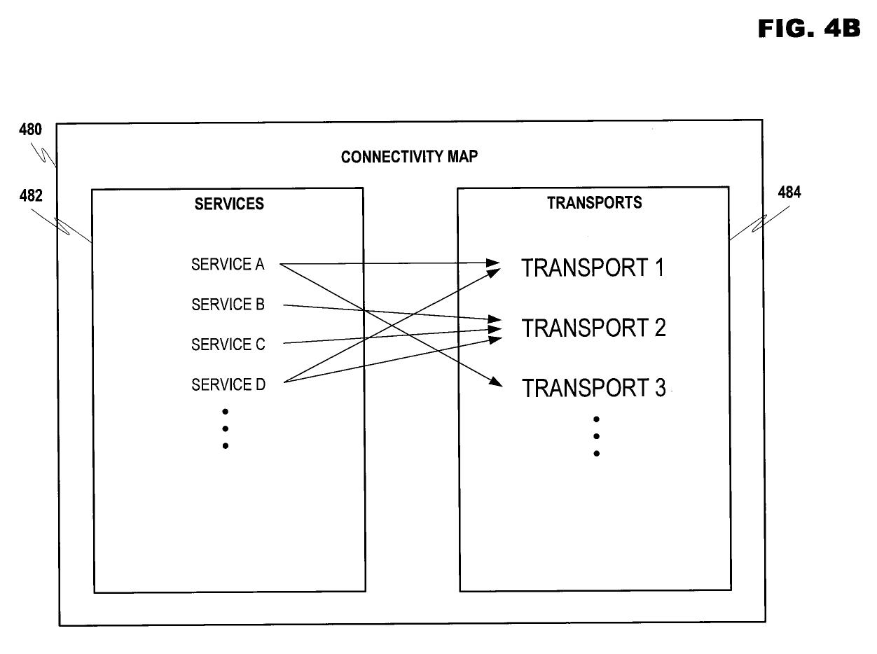

FIG. 3 discloses an example of billboard functionality in accordance with at least one embodiment of the present invention. Billboard 300 may comprise a shared memory space established amongst one or more wired or wireless devices. The scenario disclosed in FIG. 3 may further include a protocol such as UPnP 310 installed on a device (e.g., device A 200), and Bluetooth™ SDP 320 installed, for example, on device B 210. Billboard 300 may interact with these protocols using one or more services installed on devices A 200 and B 210, such as example billboard services BB UPnP service 312 and BB SDP service 322. BB services 312 and 322 may typically be components of UPnP and BT architecture but they may be components of a NoTA architecture, an example configuration of which is described in detail below with respect to FIG. 4.

UPnP 310 may offer various services locally on device A 200. These services may include UPnP media renderer service 316 and UPnP mass storage service 318. Similarly, Bluetooth™ SDP 320 may provide BT OBEX service 316 and BT mass storage service 328 on device B 210. It is important to note that these specific services have been used only for the sake of example in the present disclosure, and are not intended to limit the scope of services usable with various embodiments of the present invention. While these example services would normally only be accessible to applications residing on the same service domain, the present invention, in accordance with at least one embodiment, may provide for the interaction of various services and/or applications, regardless of the domain on which a service resides.

At least one embodiment of the present invention may operate by creating service information entries corresponding to services offered on each device in billboard table 300. In the scenario disclosed in FIG. 3, BB UPnP node 314 and BB SDP node 324 may create service information entries UPnP media renderer service 316A and UPnP mass storage service 318A, as well as BT OBEX service 316A and BT mass storage service 328A, respectively. These service information entries exist in a common billboard table 300, despite the protocols and services actually residing on separate devices. Further, the service information entries may provide information about services to other services and/or applications, such as the name of the service, service properties, pairing & authentication information utilized in accessing a particular service and/or transport mediums usable with each service. This service information may be obtained, for example by utilizing BB SDP service 324 if billboard table 300 wants to be used from the BT domain, or BB UPnP 314 service if billboard table 300 is wants to be utilized from the UPnP domain. It may also be possible that some architectures, such as NoTA, support billboard service directly. NoTA services 302 may be utilized, in accordance with at least one embodiment of the present invention, to establish the initial communication between devices A 200 and B 210 via a wireless communication medium in order to establish a shared memory space that will be utilized as Billboard table 300.

### III. Underlying Architecture

FIG. 4A discloses an example of an underlying logical architecture that may be utilized in implementing NoTA. NoTA may be configured as multiple subsystems (e.g., 400 and 420) coupled by interconnect 450. NoTA interconnect 450 may comprise two layers: High Interconnect (H_IN) layer 452 and Low Interconnect (L_IN) layer 454 coupled by switch 456. Low interconnect layer 454 may include ISO/OSI layers L1-L4 and may provide transport socket type interface upwards. High Interconnect layer 452 may act as the middleware between L_IN 454 and the higher level Application nodes (AN) 402 and Service nodes (SN) 422 residing in subsystems like 400 and 420. Key H_IN 452 functionality is to provide client nodes (AN 402 or SN 422) on top a direct access to services (without having to disclose the location of the latter). Communication may be connection-oriented, meaning that before any service or data communication takes place, connection setup procedures need to be carried out. Security features have been added to countermeasure the identified threats. NoTA is an architecture that may be used to provide intra-device service access, making it possible to build independent subsystems providing both services and applications. In an example implementation there may be several individual NoTA devices involved in direct inter sub-system communication.

FIG. 4B discloses another underlying construct that may be implemented in various embodiments of the present invention. Connectivity map 480 may be utilized to map the various services offered on the one or more devices participating in billboard table 300 to various transport mediums that may be utilized with each service. In the present example, transport mediums may comprise wireless communication mediums such as Bluetooth™, WLAN, Wibree™, wUSB, etc. In addition, the present invention, in accordance with at least one embodiment, may also be that radio technologies can be used with several protocols (e.g., Bluetooth protocols may be implemented over WLAN). However, the present invention is not specifically limited to using these particular wireless communication mediums, and may be implemented with other wireless communication mediums that are usable by services offered by various devices. In this example, Services offered by the devices may be listed under services 482, and the corresponding available transport mediums are listed under transports 484. Arrows between services 482 and transport mediums 484 indicate the one or more transport mediums usable by each service. The information in connectivity map 480 may, in accordance with various embodiments of the present invention, create a binding between billboard table content (e.g., service offerings) and connectivity map table content (e.g., available device connectivity configurations) so that this information may be utilized, for example, by applications in determining an appropriate transport medium to utilize with a particular service. Where two or more transport mediums are available, a particular transport medium may be selected based on various characteristics such as speed, traffic, priority of executing the service, other active wireless communication mediums, etc.

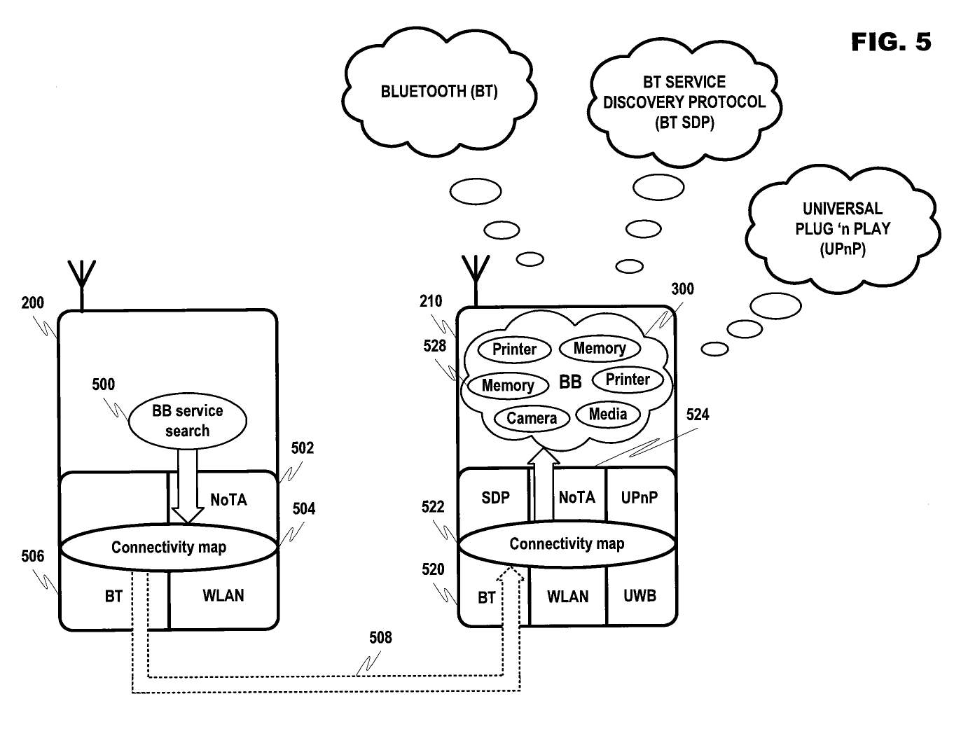

Now referring to FIG. 5, an example depicting a wireless transaction between device A 200 and device B 210 is disclosed in accordance with at least one embodiment of the present invention. In this instance, BB service search 500 on device A 200 may require the use of a particular service. Further, billboard table 300 may reside on device B 210. Regardless of the actual location of the service required by BB service search 500, a query may be made of billboard table 300 to gain access to a corresponding service node. This is because all available service information on the one or more devices participating in billboard table 300 is centrally located, reducing the steps required to access each service, and therefore, increasing the speed of access for available services. In addition, various embodiments of the present invention may include more than one billboard table 300 established between the linked devices. These billboard tables 300 may interact with each other to create a shared information pool that services may access.

BB service search 500 may, for example, using NoTA service 502 residing on device A 200 in order to access billboard table 300. In this example, connectivity map 504 may map to at least Bluetooth™ 506 as a transport medium usable by NoTA service 502. Other wireless communication mediums may also be usable as transport mediums, however in this example Bluetooth™ 506 is selected (e.g., by a user, by BB service search 500, by an application calling BB service search 500, etc.) A Bluetooth™ wireless link 508 may then be utilized to communicate between device A 200 and device B 210.

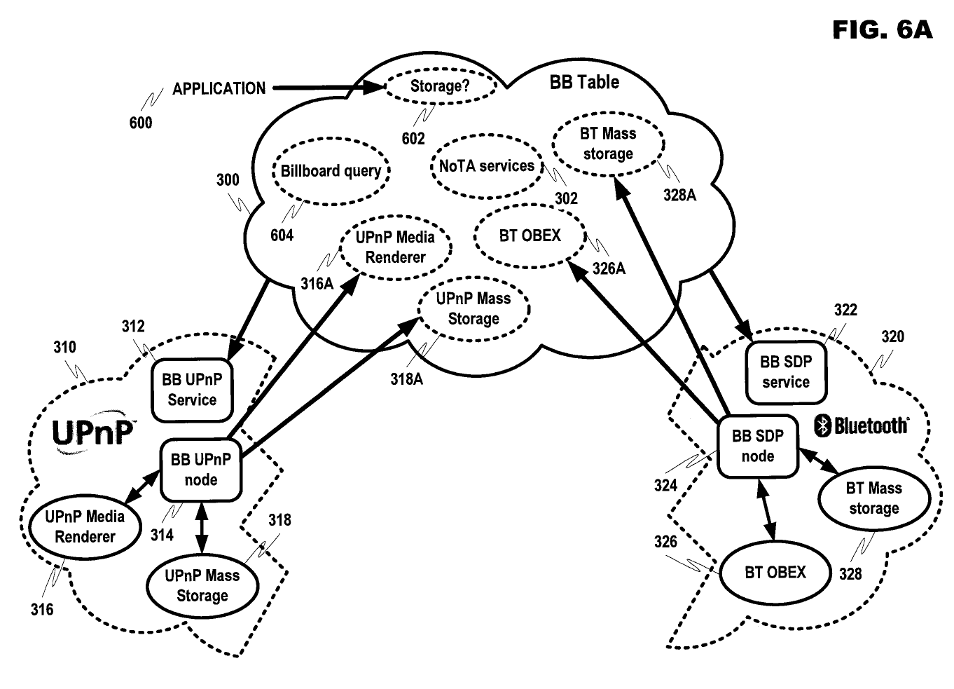

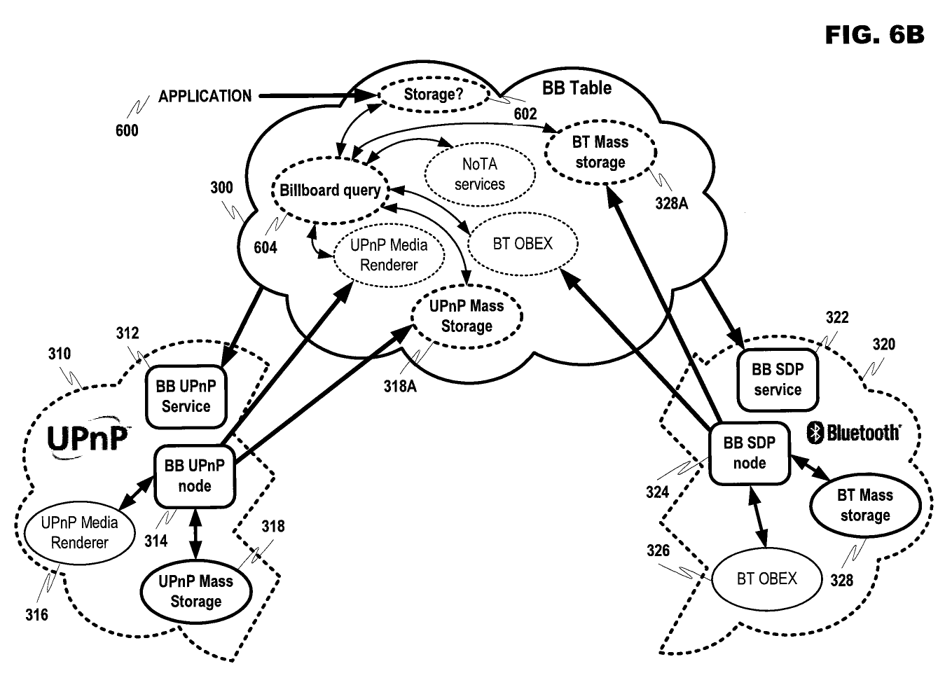

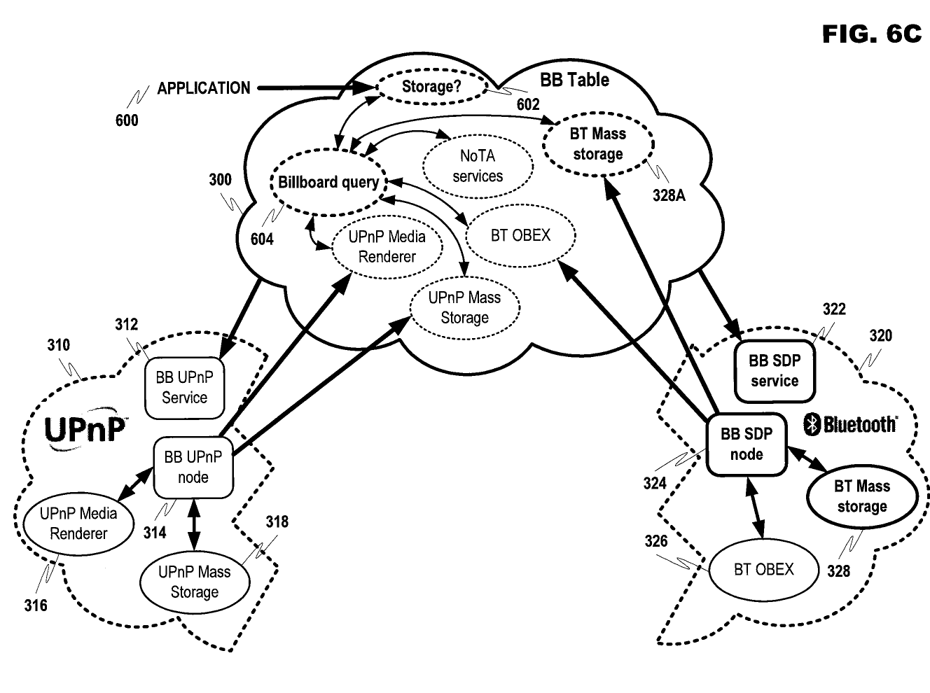

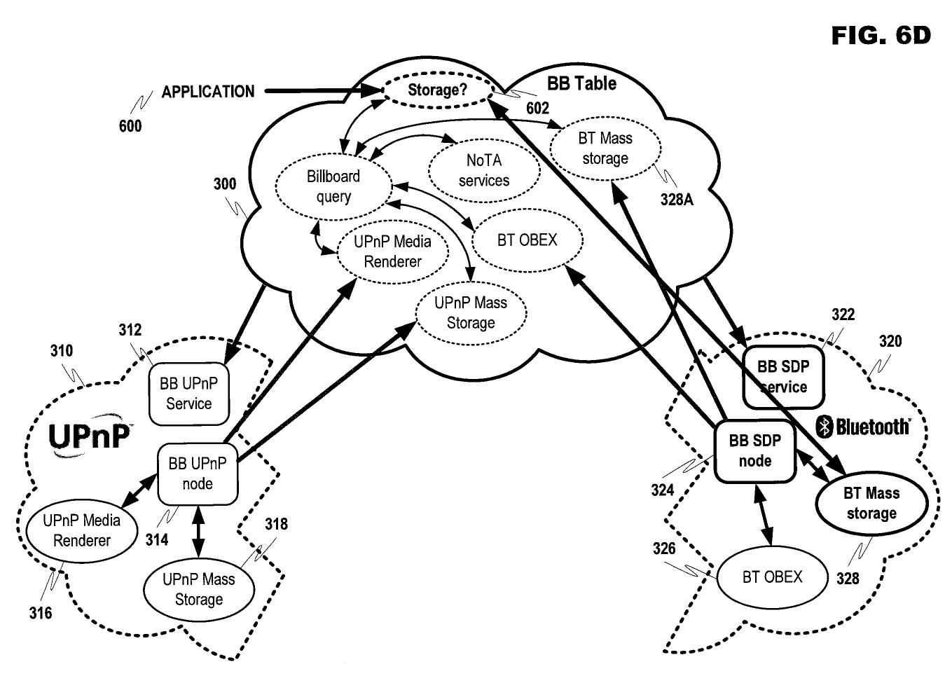

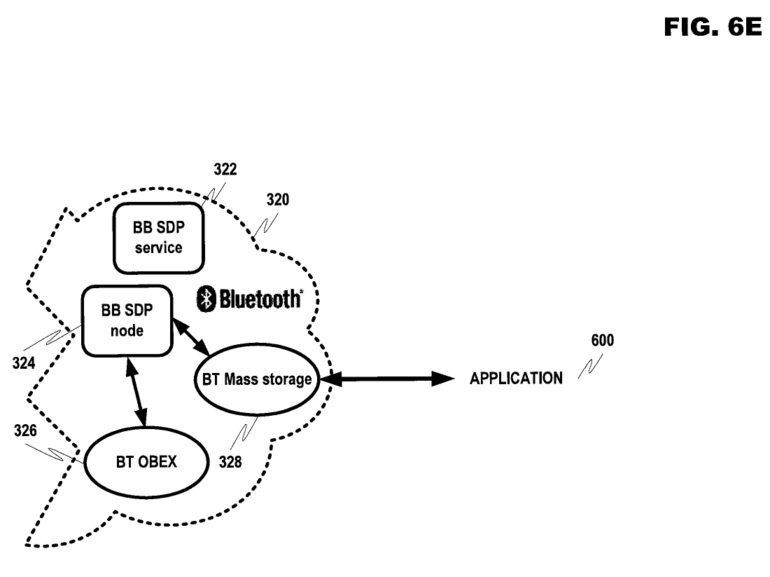

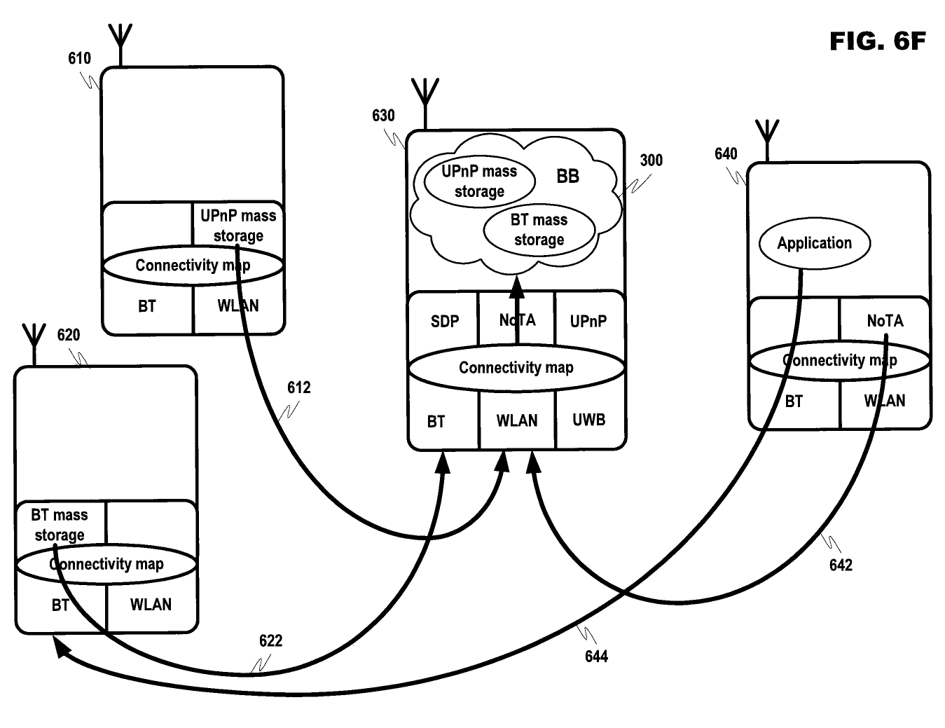

The wireless inquiry sent by device A 200 may then be received by device B 210. Bluetooth™ resources 520 in device B may correspond to (e.g., may be usable by) NoTA service 524 as determined by a mapping in connectivity map 522. NoTA service 524 may provide access to search billboard table 300, which may contain various service information entries 528 corresponding to various services available in the linked wireless communication devices. Again, while two devices are shown in the example of FIG. 5, more than two devices may participate in billboard table 300, including service nodes 528 corresponding to services that are offered by each device. BB service search 500 may then perform an inquiry of the service information entries 528 available in billboard table 300 in order to determine if any of the services corresponding to service information entries 528 will be suitable for the parameters specified in the search. An example inquiry of billboard table 300 is now described with respect to FIG. 6A-6E.

### IV. Example Application/Service Node Interaction

FIG. 6A-6E disclose an example usage scenario in accordance with at least one embodiment of the present invention. In FIG. 6A, an example situation is shown wherein application 600 running on one of the devices participating in billboard table 300 may have a requirement for storage as indicated at 602. As a result, access to a service providing storage activities may be desired in order to support application 600. This inquiry may be performed, at least in part, by a billboard query 604.

An inquiry process in accordance with at least one embodiment of the present invention is shown in FIG. 6B. Storage inquiry 602 may be referred billboard query 604, which queries all of the service nodes in billboard table 300 in order to determine the services that may potentially fulfill the needs of Application 600. In FIG. 6B two service nodes have been highlighted as potentially corresponding to services appropriate for storage requirement 602. The potentially applicable service information entries are UPnP mass storage 318A and 8T mass storage 328A. Billboard query 604 may further obtain information related to the services from their respective nodes. For example, property information may be supplied by service information entries 318A and 328A to application 600 through billboard query 604. Information regarding transport mediums usable by each service may also be obtained through the use of connectivity map 480. All of the aforementioned information may be used in determining which service to select for supporting application 600. For example, the properties of a particular service may be more useful for, or accessible to, application 600. A particular service may also be selected because a usable transport medium is better able to support the activity to be performed because other transport mediums already have too much traffic, are experiencing interference, conflict with other transport mediums, etc.

In FIG. 6C, BT mass storage service information entry 328A has been selected to support application 600. This selection may be made automatically by control elements in the one or more devices supporting billboard table 300, by application 600, by user selection of a preferred service and/or transport medium, etc. Billboard query 604 may then obtain all of the information necessary to access BT Mass storage service 328 from BT mass storage service information entry 328A. This information may include, for example, property information and transport medium information that may be further conveyed to application 600 in order to facilitate a direct link between application 600 with BT Mass storage service 328. An example direct linkage is shown in FIG. 6D, and a communication transaction resulting between application 600 and BT Mass storage service 328 is further shown in FIG. 6E.

Now referring to FIG. 6F, an example of devices providing services to other devices via billboard table 300 in accordance with at least one embodiment of the present invention is disclosed. In this example, devices 610 and 620 may be wirelessly coupled to device 630. A UPnP protocol in device 610 may couple to device 630 via WLAN, as shown at 612, in order to create a UPnP mass storage service node in billboard table 300. Similarly, a BT mass storage service in device 620 may utilize the BT SDP protocol to create a service node in billboard table 300 via Bluetooth™ communication 622. After these devices have established billboard table 630, device 640 may enter.

Device 640 includes an application that requires a storage service. Device 640 may then access billboard table 300 on device 630 as shown at 642. This connection may be made, for example, utilizing a NoTA service communicating over WLAN. Device 640 may access billboard table 300 in order to query the available services. If more than one applicable service is located, a selection may be made as to the service most appropriate for the application. In this example it is determined that the BT mass storage service will be most appropriate to assist the application in device 640. Device 640 may then obtain information from the BT mass storage node, such as property and transport medium information, that will be needed in order to access the BT mass storage service. Device 640 may then access the BT mass storage service on device 620 in order to establish a direct connection between the application and the service a shown at 644.

V. Example Source Selection Scenario when a Plurality of Sources are Available.

In situations where two or more apparatuses are able to provide the same resources to an apparatus wishing to access said resources, a decision to utilize one apparatus over another apparatus may depend on various factors. An example indicator that may be used to determine a preferred source apparatus is energy. For instance, apparatuses that can provide required resources may currently be operating using a local power source (e.g., a battery) instead of external power (e.g., a wall outlet), may only operate with battery due to apparatus complexity, location, size, etc. limitations, may be operating utilizing a depleted energy source, may be quickly depleting stored energy due to substantial processing and/or communication tasks, etc. Indicators, such as those listed above, may be processed in order to determine apparatus condition, which may in turn be evaluated in view of device-level and/or system-level management objectives. In this way, sources for required resources may be selected based on the management objective.

However, even if users could identify apparatuses that are able to provide access to required resources and corresponding apparatus condition information, the level of skill required in order to make a determination as to which source to select would still be problematic for novice users, and possibly even for experienced users. In particular, it would require users to accumulate and comprehend condition information pertaining to at least the apparatuses that can provide the required resources, and then to determine which of these apparatuses to utilize based on some overall management goal (e.g., optimizing power in one or more apparatuses, system power optimization, etc.) Users would then be required to configure a connection to selected apparatuses/required resources, which would already have been burdensome in view of the potential pitfalls discussed above.

In addition, the above source apparatus selection process example does not take into account changes in the condition of source apparatuses as the desired resource is being accessed (e.g., energy depletion), or the source and consuming apparatuses losing their communication connection due to environmental interference, moving outside of communication range, one of the apparatuses crashing, etc. Such foreseeable conditions or events would unavoidably require repeating the entire process for each occurrence of a failure mode.

### VI. Example of Apparatus Configuration Incorporating Quality of Service (QoS).

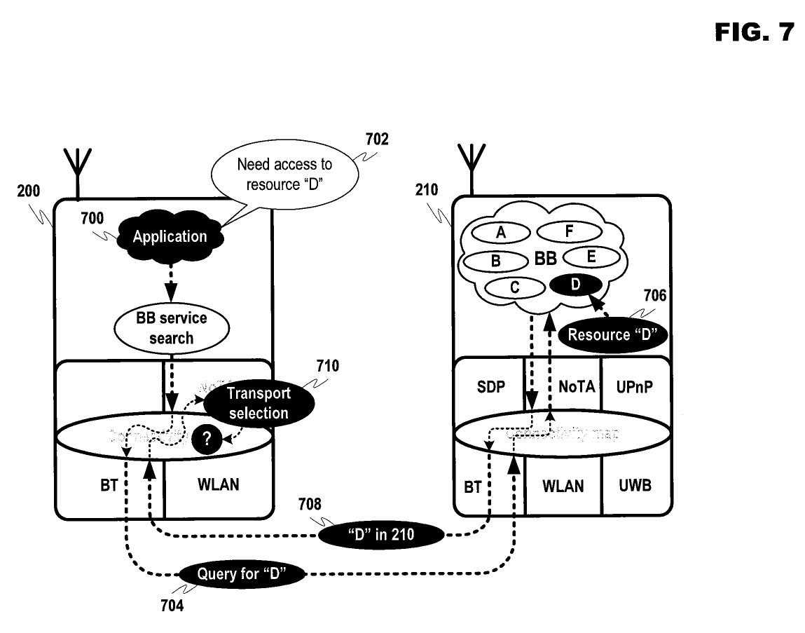

Now with respect to FIG. 7, drawing elements that were previously discussed in regard to other figures are not identified in FIG. 7 in order to reduce the complexity of the figure. In accordance with at least one example embodiment of the present invention, FIG. 7 discloses a possible interaction between apparatuses 200 and 210. Interaction between only two apparatuses has been disclosed in FIG. 7 for the sake of explanation herein, and thus, the present invention is not limited to use with only two apparatuses. Interaction in this scenario may be initiated by any participating apparatus, but in the disclosed example is triggered by application 700 in apparatus 200. Application 700 may be, for example, a software/program module that upon activation, execution or user interaction creates requirements to access a resource (e.g., as shown at 702).

In accordance with the previously disclosed example embodiments of the present invention, BB search 500 may utilize a transport, such as Bluetooth™ (BT), to perform queries 704 of available resources in the NoTA environment. The same transport may further be used to exchange connectivity map information, which may eventually be utilized in transport selection 710 when appropriate transports are to be selected. The accumulation of this available resource information may help facilitate the identification of potential providers for requested resources, such as resource “D” requested by application 700. For example, information in BB 500 may disclose that resource “D” 706 actually resides on apparatus 210 in the NoTA environment, and therefore, apparatus 210 is able to act as a “provider” for resource “D” to apparatus 200.

A response 708 to inquiry 704 may be returned identifying one or more potential resources (e.g., services, databases, etc.) residing on at least one provider (in this case apparatus 210). However, subsequent transactions cannot be limited to utilizing the transport that was initially selected in order to perform the query. For example, high speed, low power, low throughput transports like Ultra Low Power Bluetooth™ may be adequate for performing initial queries, but would not be likewise appropriate for subsequent communication if large amounts of data are to be conveyed, a low amount of errors is required or other similar requirement exist.

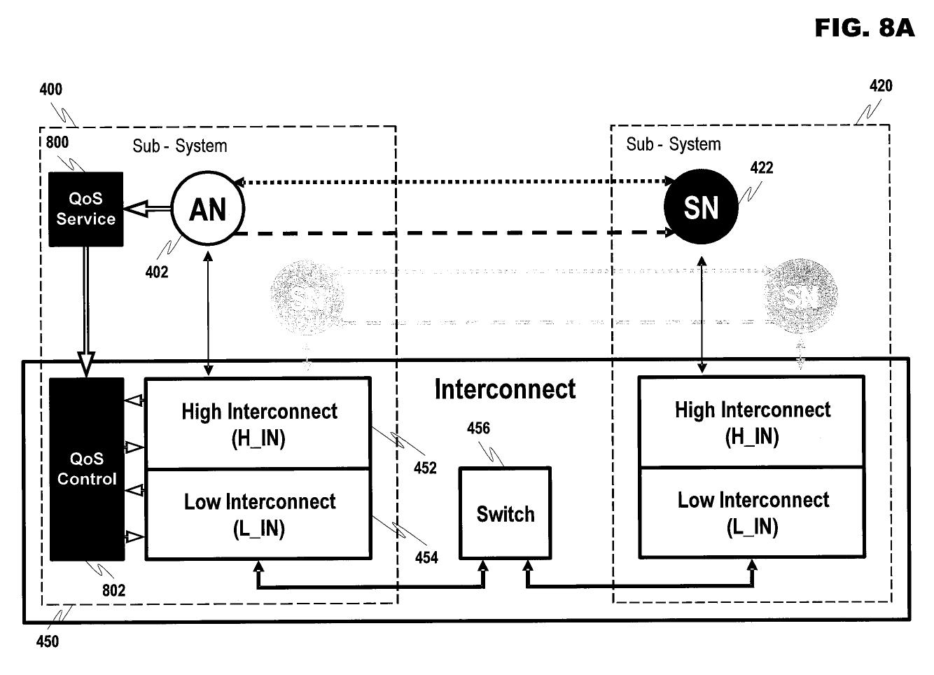

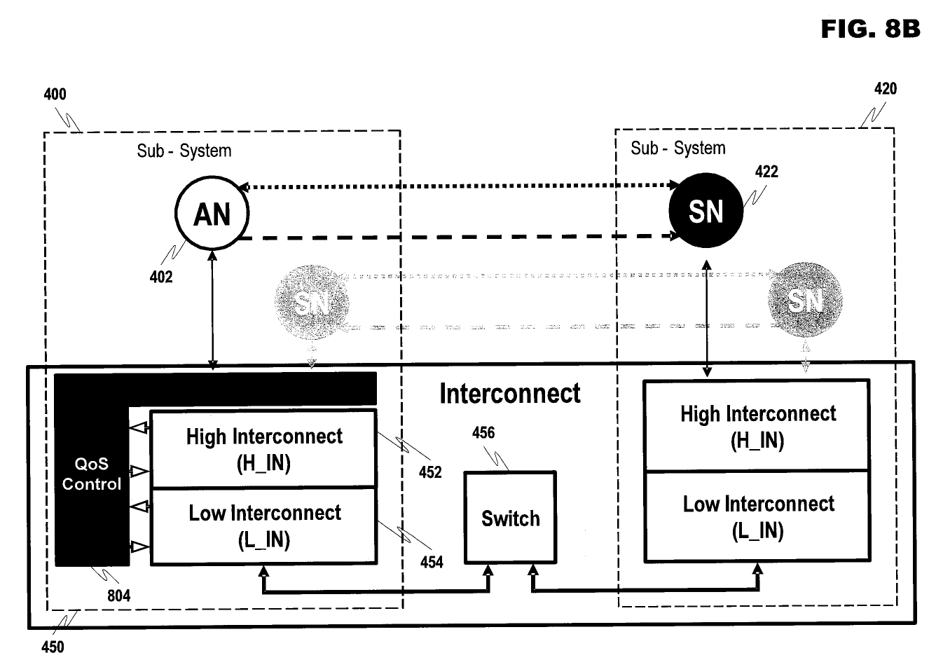

In accordance with various embodiments of the present invention, FIG. 8A introduces a possible configuration for incorporating transport selection based on a required quality of service. While the required quality of service may be required based on information provided by the requesting entity (e.g., application 700), the actual selection of a particular wired or wireless communication transport is transport independent. More specifically, the requesting entity has no visibility regarding the particular transport that is selected. Instead, the requesting entity specifies the type of performance (QoS) required, and relies on elements of the NoTA system to provide a transport that will satisfy the performance requirements.

The example implementation disclosed in FIG. 8A includes a QoS service, which is represented in FIG. 8A by QoS service node 800, and QoS control element 802. Application 700 may utilize AN 402 to interact with QoS service node 800 in accordance with the various interaction examples presented above. A portion of this interaction may include the passing of QoS criteria information to the QoS service (and/or QoS control 802), which may utilize this information to select one or more transports that can provide access to the resource while maintaining the required QoS. In the configuration shown in FIG. 8A, usage of the QoS service may be optional. Use may be dictated by application settings, rules governing service usage, user configuration, etc. Moreover, the QoS criteria information may be also provided, in whole or in part, from sources in the NoTA environment besides the requesting entity. For example, users may configure apparatuses to favor low power (and hence low speed/throughput) communication transports in order to conserve power in portable apparatuses. However, the configuration may also allow for exceptions to this directive, such as if certain applications are requesting access to certain resources (e.g., a multimedia player accessing stored data). QoS criteria information may also be provided by programs that monitor device operation, control the handling of concurrent communication, manage security, establish operational priority, etc.

In facilitating communication for application 700, QoS control element 802 may utilize QoS criteria when binding a socket corresponding to the application in the L_IN level to one or more transport sockets. The number of transports or the identity of the transports is not of consequence to the application level since there is no visibility of this choice to application 700. Instead, information is conveyed to and from the application via the single socket assigned in the L_IN level. In accordance with at least one example embodiment of the present invention, QoS control element 802 then becomes tasked with determining one or more transports that are able to fulfill the quality requirements (as set forth by the QoS criteria). The socket corresponding to the application may then be bound to the sockets corresponding to the one or more transports.

Selecting transports may comprise the analysis of all usable communication transports and subsequent selection of one transport or the selection of a plurality of usable transports. For example, the transport that is deemed to be best able to provide the required QoS, based on the QoS criteria, may be selected and access may then be attempted. In the instance that access cannot be granted, or the requested QoS cannot be maintained, the process may query for an alternative transport and/or may select another resource provider (e.g., another apparatus in the NoTA environment). In another scenario, the QoS control may be configured to create a group of usable transports. This group may, for example, include all of the transports that were identified as able to provide access to the resource and the requested QoS, and may further be placed in a preferred order for use. The preferred order may be determined based on the QoS criteria information, apparatus condition information, user configuration information, etc. As a result, access may be attempted with the most preferred transport. In instances where access is unsuccessful, the next most preferred transport may be utilized without having to reinitiate the entire determination process. This grouping technique may also be used with resource providers. For example, a plurality of providers may each have a corresponding group of usable transports.

An alternative configuration usable with various exemplary embodiments of the present invention is disclosed in FIG. 8B. As opposed to FIG. 8A where use of the QoS Service (e.g., via QoS Service node 800) is optional, in FIG. 8B QoS control 804 may be integrated into the lower level communication layers (e.g., H_IN 452 and L_IN 454). In at least one instance, functionality may be provided to check communication requests coming from higher operational levels (e.g., an application represented by AN 402) to determine if QoS is also being provided. In cases where no QoS criteria information is available, the QoS control may not participate in selecting transports (unless overall QoS criteria has been set forth from another source).

### VII. Example Application and Process Flow.

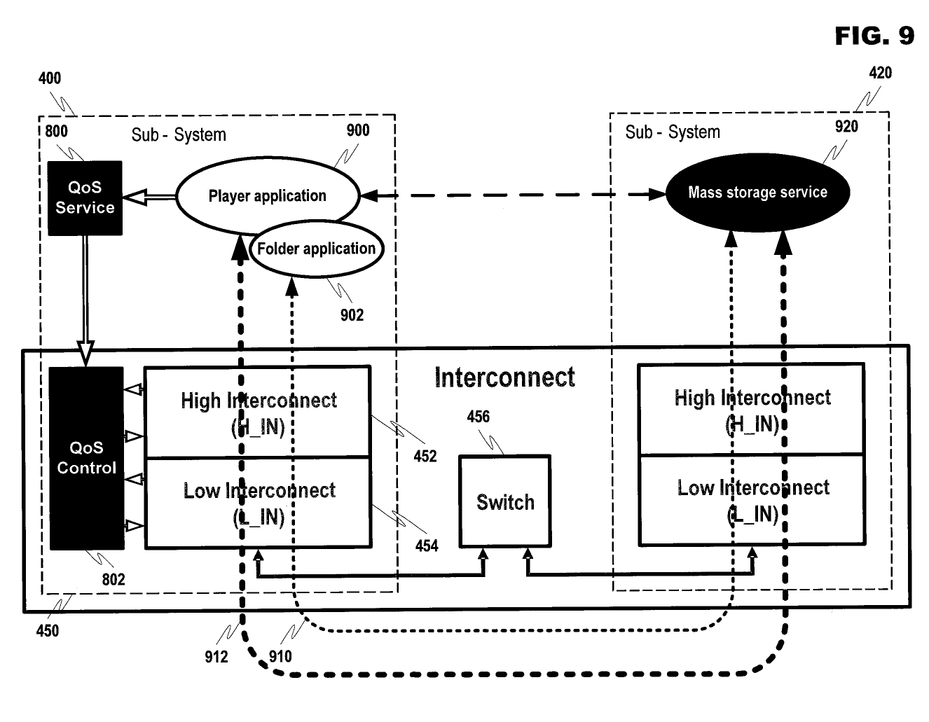

Now referring to FIG. 9, an example application which may employ various example embodiments of the present invention is disclosed. In this example player application 900 is being executed on a first apparatus 400. Player application 900 may be configured for the playback of audio and/or video clips that are loaded into it. Multimedia files usable by player application 900 be stored on one or more of the apparatuses participating in the NoTA network. However, a single interface for facilitating access to these files, regardless of their physical location, may be provided by mass storage service 920. Folder application 902 may be a program module called by, or integrated within, player application 900 to facilitate the browsing and/or selection of multimedia files. Once a desired multimedia has been found and selected by a user, then the file may be loaded into, or streamed by, player application 900 for presentation.

The requirements of the browsing and/or selection aspects described above may be very different from those for loading and/or playback. For example, the amount of data transmitted between folder application 902 and mass storage service 920 during the browsing and/or selection operation may be a lot smaller than the amount seen during loading and/or streaming playback. As a result, the ability to utilize different transports based on the required QoS for each interaction may be beneficial. For example, a resource (e.g., mass storage service 920) may be first accessed when a user is browsing for a desired file. This interaction may be supported by low power/low speed/low throughput transport (e.g., such as ULP-BT) as disclosed at 910. This may allow the apparatuses to conserve resources that would have otherwise been expended using a more robust communication transport. Further, error correction is not so important in this transaction since small amounts of data are only being exchanged sporadically and there is no limit on the number of retransmissions that are needed to successfully convey data. Then, after the selection of at least one multimedia file for playback has been completed, a second transport 912 may be employed. The second transport 912 may be selected based on the particular QoS criteria of the loading and/or playback functionality. For example, the streaming of video may require a higher speed/higher throughput transport that supports error correction. The use of a transport with these qualities (e.g., WLAN) may help to ensure smoother playback.

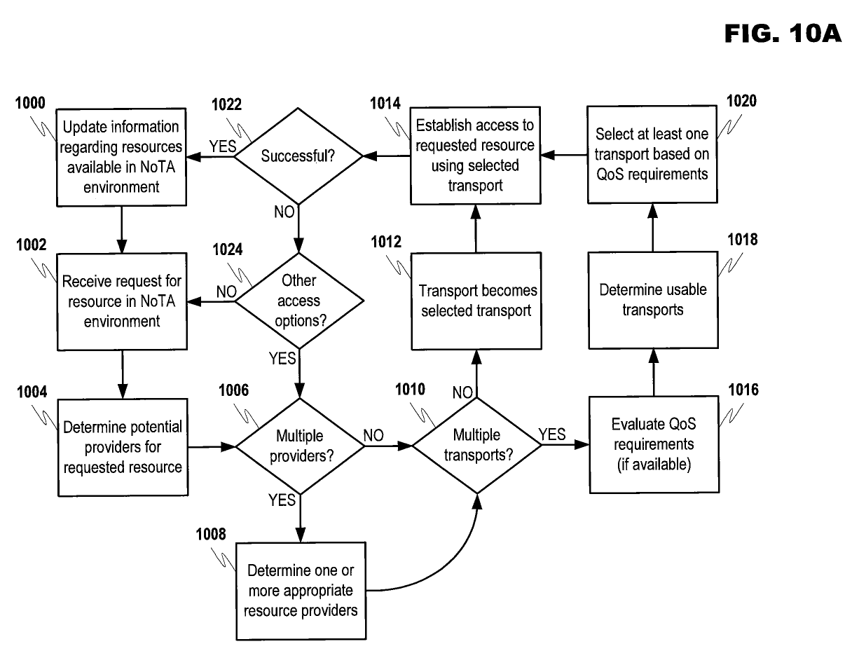

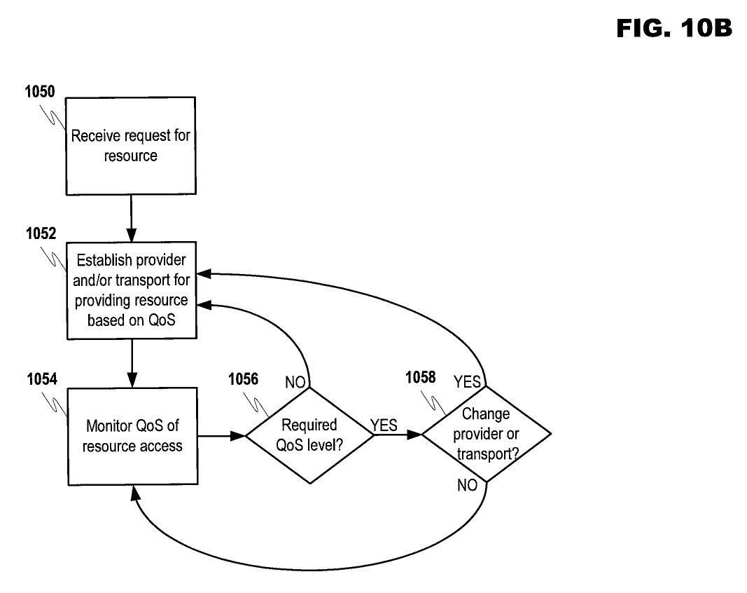

A flowchart for an example process in accordance with at least one embodiment of the present invention is disclosed in FIG. 10A. After updating the NoTA resource availability information (e.g., via a BB service search) in step 1000, resource access requests may be received into the NoTA environment in step 1002. In actual practice, NoTA resource availability information may be refreshed periodically to help ensure the accuracy of the information at instances when resource requests are received. A query of the resource availability information may be performed in step 1004 in order to determine if and where the required resource is available. If multiple providers are identified in step 1006, then in step 1008 a selection may be made amongst the possible resource providers. The selection may be based on information such as the current operating condition (e.g., apparatus functionality, energy level, level of concurrent communication, security configuration, etc.) of each apparatus on which an occurrence of the required resource resides. Additional criteria that may be considered may correspond to the required resource, such as the number of requesting entities currently being serviced by each occurrence of the required resource. A single resource provider being selected, or alternatively, the selection may result in multiple (e.g., a group) of resource providers. Groups of providers may, for example, be arranged in an order of preference based on the available information.

Regardless of whether one provider or multiple providers have been identified, a determination of whether one or more transports are available for use in accessing the providers, and thereby the required resource, may be performed in step 1010. There may be instances where only one transport is deemed to be usable, for example in cases where there is only one common communication transport supported by the apparatuses on which the requesting entity and the resource reside. If only one transport is determined to be available in step 1010, then the available transport may be selected in step 1012. The selection of the available transport may be followed by an attempt to access the required resource using the selected transport in step 1014.

Other considerations may occur when multiple transports are determined to be available in step 1010. Initially, QoS requirements may be evaluated (if available) in step 1016. QoS requirements may be utilized directly, or may be used to create QoS criteria, for use in step 1018 when determining the transports that may be usable in accessing the required resource. The QoS criteria may be supplied by the requesting entity alone or combination with information provided by other entities within the NoTA environment. For example, current apparatus and/or required resource status may be provided for making the determination of usable transports.

One or more transports may then be selected in step 1020. As previously set forth above and in accordance with various example embodiments of the present invention, a single transport may be selected, or multiple transports may be selected. In situations where multiple transports are selected (e.g., as a group), the transports may be organized in preferred order based on, for example, the QoS criteria or other available information in the NoTA environment. The selected transport may then be utilized in step 1014 in an attempt to access the required resource.

Regardless of whether one transport (step 1012) or multiple transports (step 1020) were selected, in step 1022 a determination may be made as to whether the attempt to access the required resource was successful in step 1014. If the access attempt was not successful, then in step 1024 a determination may be made as to whether other access options already exist. For example, in situations where multiple resource providers and/or multiple transports were identified in steps 1006-1020, the next most preferred resource provider and/or transport may be selected (e.g., the process may return to step 1006 to select another resource provider or transport in accordance with a preferred order of use). Otherwise the system may return to step 1002 to repeat the identification of potential providers for the required resource. On the other hand, if the resource was successfully accessed in step 1022, then the process may return to step 1000 to await the next instance where access to a resource is required.

FIG. 10B discloses a flowchart of an example process for managing access to a required resource in accordance with at least one example embodiment of the present invention. After a requirement for a resource in the NoTA environment is realized in step 1050, access to this resource may be established in step 1052. For example, the process disclosed in FIG. 10A may be applied in step 1052 in order to select a resource provider and one or more transports for communicating with the resource provider, or in alternative implementations a group of resource providers with each resource provider having one or more possible transports, for providing access to the resource in accordance with the required QoS.

The resource access facilitated by the selected provider(s)/resource(s) may be monitored in step 1054. If in step 1056 it is determined that access to the required resource via the selected provider/transport cannot be maintained in accordance with the required QoS, then the process may return to step 1052 in order to establish a new provider/transport configuration that meets the required QoS. Reconfiguration may involve selecting the next transport if the original selection process (e.g., such as disclosed in FIG. 10A) established a group of potential transports. The transport may be selected in view of a preferred order of usage established for group of transports. Otherwise, the provider/transport selection process may be reinitiated to select new providers and/or transports.

If the required QoS level is being maintained as determined in step 1056, the process may proceed to step 1058 to determine whether to change the provider or transport. Changes may be made in the selected provider based on various criteria such as the condition of the selected provider (e.g., power, communication or processing load, etc.), the ability of another provider to provide better access to the resource, etc. The selected transport may be changed for similar reasons that may, for example, lead to improved resource access. The state (e.g., context and/or condition) of requesting nodes may be also be considered during provider and/or transport selection. If the selected provider and/or transport is to be changed, the process may return to step 1052 to reconfigure resource access (e.g., using a process like that disclosed in FIG. 10A). Otherwise, the currently configured resource access may continue to be monitored in step 1054.

While various exemplary configurations of the present invention have been disclosed above, the present invention is not strictly limited to the previous embodiments.

For example, the present invention may include, in accordance with at least one example embodiment, an apparatus, comprising means for identifying a resource to which access is required, means for identifying one or more providers for the resource, means for identifying at least one transport usable for communicating with the one or more providers, means for, if more than one transport is usable for communicating with the one or more providers, selecting at least one transport based on quality of service criteria, and means for accessing the required resource via the selected at least one transport.

Accordingly, it will be apparent to persons skilled in the relevant art that various changes in form a and detail can be made therein without departing from the spirit and scope of the invention. The breadth and scope of the present invention should not be limited by any of the above-described example embodiments, but should be defined only in accordance with the following claims and their equivalents.

What is claimed:

1. A method, comprising:
identifying a resource to which access is required;
identifying one or more providers for the resource;
identifying at least one transport usable for communicating with the one or more providers;
if more than one transport is usable for communicating with the one or more providers, selecting at least one transport based on quality of service criteria; and
accessing the required resource via the selected at least one transport.

2. The method of claim 1, wherein the one or more providers reside on at least one other apparatus that is configured to communicate wirelessly via the at least one transport.

3. The method of claim 1, wherein the quality of service criteria comprises one or more of a required speed, a required data capacity or a required error threshold level.

4. The method of claim 1, wherein at least one of a group of providers are selected or a group of transports are selected for each provider; and
the at least one of the selected group of providers or selected group of transports for each provider are arranged in a preferred order of usage that defines the next provider or transport to be selected if access to the required resource cannot be established.

5. The method of claim 1, further comprising monitoring the access to the required resource via the selected at least one transport; and
selecting another transport if required access performance determined in view of the quality of service criteria is not maintained.

6. The method of claim 1, further comprising monitoring the access to the required resource via the selected at least one transport; and
selecting another transport if the other transport is determined to be usable for providing better access performance based on the quality of service criteria.

7. A computer program product comprising computer executable program code recorded on a computer readable medium, comprising:
computer program code configured to identify a resource to which access is required;
computer program code configured to identify one or more providers for the resource;
computer program code configured to identify at least one transport usable for communicating with the one or more providers;
computer program code configured to, if more than one transport is usable for communicating with the one or more providers, select at least one transport based on quality of service criteria; and
computer program code configured to access the required resource via the selected at least one transport.

8. The computer program product of claim 7, wherein the one or more providers reside on at least one other apparatus that is configured to communicate wirelessly via the at least one transport.

9. The computer program product of claim 7, wherein the quality of service criteria comprises one or more of a required speed, a required data capacity or a required error threshold level.

10. The computer program product of claim 7, wherein at least one of a group of providers are selected or a group of transports are selected for each provider; and
the at least one of the selected group of providers or selected group of transports for each provider are arranged in a preferred order of usage that defines the next provider or transport to be selected if access to the required resource cannot be established.

11. The computer program product of claim 7, further comprising monitoring the access to the required resource via the selected at least one transport; and
selecting another transport if required access performance determined in view of the quality of service criteria is not maintained.

12. The computer program product of claim 7, further comprising monitoring the access to the required resource via the selected at least one transport; and
selecting another transport if the other transport is determined to be usable for providing better access performance based on the quality of service criteria.

13. An apparatus, comprising:
a processor, the processor being configured to:
identify a resource to which access is required;
identify one or more providers for the resource;
identify at least one transport usable for communicating with the one or more providers;
if more than one transport is usable for communicating with the one or more providers, select at least one transport based on quality of service criteria; and
access the required resource via the selected at least one transport.

14. The apparatus of claim 13, wherein the one or more providers reside on at least one other apparatus that is configured to communicate wirelessly via the at least one transport.

15. The apparatus of claim 13, wherein the quality of service criteria comprises one or more of a required speed, a required data capacity or a required error threshold level.

16. The apparatus of claim 13, wherein at least one of a group of providers are selected or a group of transports are selected for each provider; and
the at least one of the selected group of providers or selected group of transports for each provider are arranged in a preferred order of usage that defines the next provider or transport to be selected if access to the required resource cannot be established.

17. The apparatus of claim 13, further comprising monitoring the access to the required resource via the selected at least one transport; and
selecting another transport if required access performance determined in view of the quality of service criteria is not maintained.

18. The apparatus of claim 13, further comprising monitoring the access to the required resource via the selected at least one transport; and
selecting another transport if the other transport is determined to be usable for providing better access performance based on the quality of service criteria.
